(19) United States
(12) Patent Application Publication
(10) Pub. No.: US 2026/0192848 A1
(43) Pub. Date: Jul. 9, 2026

(54) LONGITUDINALLY ADJUSTABLE OPERATING UNIT, KIT-OF-PARTS AND STEER-BY-WIRE SYSTEM

(71) Applicant: Schaeffler Technologies AG & Co. KG, Herzogenaurach (DE)

(72) Inventors: Benjamin Severin, Baiersbronn (DE); Jannick Altherr, Bühl (DE); Martin Vornehm, Bühl (DE)

(73) Assignee: Schaeffler Technologies AG & Co. KG, Herzogenaurach (DE)

(21) Appl. No.: 19/131,944

(22) PCT Filed: Aug. 10, 2023
(86) PCT No.: PCT/DE2023/100588

§ 371 Date: May 22, 2025

(30) Foreign Application Priority Data
Nov. 24, 2022 (DE) 10 2022 131 133.3
Dec. 20, 2022 (DE) 10 2022 134 115.1

(51) Int. Cl. B62D 1/185; B60R 16/027; B62D 6/10

(52) U.S. Cl. CPC B62D 1/185; B60R 16/027; B62D 6/10

(57) ABSTRACT

The disclosure relates to a longitudinally adjustable operating unit for influencing, by a user, a direction of travel of a motor vehicle. The operating unit includes a telescopic pull-out device having a guide tube, in or on which at least one first pull-out tube is guided relative to the guide tube and is translationally movable via a rotatable spindle, which extends coaxially and axially, at least in portions, in the first pull-out tube. The telescopic pull-out device is coupled to a steering means, and a plurality of electrically insulated conductors extend axially through the telescopic pull-out device to electrically connect a first axially stationary electrical connection to a second electrical connection which can be axially moved by the pull-out device. The electrical conductors are combined to form a cable assembly which extends in an axial direction through the pull-out device and has a longitudinally elastic shape.

The present invention relates to a longitudinally adjustable operating unit for influencing, by a user, a direction of travel of a motor vehicle, comprising a telescopic pull-out device having a guide tube, in or on which a first pull-out tube is guided so as to be translationally movable relative to the guide tube, and the telescopic pull-out device is coupled on the one hand to a steering means, wherein an actuation of the steering means representing the steering direction causes a rotation of a spindle which extends coaxially and axially at least in sections in the first pull-out tube, wherein a plurality of electrically insulated conductors extend axially through the telescopic pull-out device to electrically connect a first, axially stationary electrical connection to a second electrical connection which can be axially moved by the pull-out device. The invention also relates to a kit-of-parts and a steer-by-wire system.

Electric steering devices are used—among other applications, in motor vehicles—to receive a directional request from a driver and convert it into corresponding movements of one or more road-end wheels. Compared to purely mechanical steering devices, with electric steering devices, a distinction is made between electrically-assisted steering devices and fully electric steering devices, so-called “steer-by-wire” steering devices. In particular, these steer-by-wire steering devices have the advantage that the operating unit can be positioned relatively freely within the vehicle independently of mechanical connection components, which in addition to cost savings when distinguishing between right-hand and left-hand drive vehicles, for example, also improves accident behavior due to the absence of a steering column. Furthermore, the operating unit can be brought into a stowed position, which is also used, for example, with fully automatic steering.

A steer-by-wire steering system within the meaning of the present invention is to be understood as meaning a steering system which essentially consists of what is termed a hand wheel actuator (HWA), for example the actuator system around the commanding vehicle steering wheel, and a road wheel actuator (RWA), i.e., the actuators acting on the steering mechanism connected to the vehicle wheels. The steering signal is here transmitted by wire from the HWA to the RWA.

Such systems are fundamentally known from the prior art. For example, DE 10 2015 224 602 A1 discloses an adjustable steering column for a steer-by-wire steering device of a motor vehicle, comprising an actuating unit which includes a steering spindle which is mounted in a casing unit so that it can rotate about a longitudinal axis, wherein the casing unit has a first casing tube, in which at least one second casing tube is arranged in a non-rotatable manner with respect to the longitudinal axis and is mounted in a telescoping, axially displaceable manner, wherein an actuator is connected to the first and the second casing tube, by which the second casing tube can be moved in and out axially relative to the first casing tube, and the one spindle drive comprises a threaded spindle which is arranged to be parallel to the longitudinal axis and can be driven in rotation by an electric servomotor, which is supported on one casing tube and which is screwed into a spindle nut which is attached to the other casing tube in a non-rotatable manner, wherein the threaded spindle extends inside the first casing tube, and the spindle nut is attached to the second casing tube.

DE 10 2018 212 696 B3 also discloses an adjustment drive for a motorized adjustable steering column for a motor vehicle, comprising a motorized drive unit and an external threaded spindle which has an external thread and a coaxial internal thread in which an internal threaded spindle engages, wherein the external threaded spindle and the internal threaded spindle can be driven by the drive unit to rotate relative to one another about an axis. To provide an adjustment drive that requires a lower drive torque and offers an optimized free adjustment path, DE 10 2018 212 696 B3 proposes that the external threaded spindle engages with its external thread in a drive nut, wherein the drive nut or the internal threaded spindle can be driven in rotation by the drive unit and is supported in the direction of the axis relative to the drive unit.

With regard to the further development towards autonomous driving, the aim is to enable the driver of the vehicle to retract the steering wheel almost completely towards the dashboard in autonomous driving mode to achieve an improved comfort area without a steering wheel that can be perceived as interfering, which also allows completely new design concepts for the passenger compartment.

Such new designs of the passenger compartment in autonomously driving motor vehicles often result in special requirements for the steering wheel to be retracted, particularly with regard to the required travel distance, which is usually considerably greater than the travel distance for an extendable steering column in a non-autonomously driving automobile.

Implementing greater travel distances over longer spindles with the approaches known from the state of the art are critical in terms of installation space and stability.

In conventional concepts, for example, the spindle would need to be longer than the steering column, which would lead to a collision with the steering wheel when retracting. In addition, passive vehicle safety is significantly impaired as there is a penetrator in the direction of the driver.

In the spindle drives mentioned at the outset, the spindle nut on the spindle drive is usually self-locking, which means that in the event of an accident, an impact force on the steering wheel is supported by the self-locking mechanism, which increases the risk of injury. The interposition of a crash element between the slider and the spindle nut reduces the risk of injury to the driver in the event of an accident by allowing the steering wheel to yield or move back when force is applied.

In safety steering columns of the type outlined above, crash elements of this kind are used to enable the steering wheel (or the casing tube connected to the steering wheel) to be pushed away over a distance of 80-120 mm in the event of an accident. When the steering wheel is extended, this further softens the impact of the driver's head in the event of a crash, for example, and minimizes injuries. In addition to the challenge of meeting the safety requirements for telescopic operating units, it is also regularly difficult to establish an electrical connection between the telescopic steering unit, in which a number of control elements are located in modern vehicles, and the fixed part of the corresponding telescopic extension.

It is therefore the object of the invention to provide an improved longitudinally adjustable operating unit for influencing, by a user, a direction of travel of a motor vehicle, which can provide a simple and safe electrical contact between the telescopic end and the fixed end of the operating unit. It is further the object of the invention to realize a kit-of-parts that allows a simplified assembly of a longitudinally adjustable operating unit for influencing, by a user, a direction of travel of a motor vehicle. Furthermore, it is the object of the invention to provide a steer-vy-wire system that has an optimized longitudinally adjustable operating unit.

This object is attained by a longitudinally adjustable operating unit for influencing, by a user, a direction of travel of a motor vehicle, comprising a telescopic pull-out device having a guide tube, in or on which at least a first pull-out tube is guided relative to the guide tube and is translationally movable by means of a rotatable spindle which extends coaxially and axially at least in sections in the first pull-out tube, wherein the telescopic pull-out device is coupled on the one hand to a steering means, and a plurality of electrically insulated conductors extend axially through the telescopic pull-out device to electrically connect a first, axially stationary electrical connection to a second electrical connection which can be axially moved by the pull-out device, wherein the electrical conductors are combined to form a cable assembly which extends in the axial direction through the pull-out device and has a longitudinally elastic shape.

This has the advantage that dynamic length compensation in the axial direction and positioning in or on the pull-out device of the operating unit can be realized when wiring an operating unit. The longitudinally elastic shape of the cable assembly, which can also be referred to as a cable harness, allows defined positioning, particularly in the radially inner and outer directions, by means of the inherent stress generated, for example by twisting the insulated electrical conductors without additional components, which significantly reduces the risk of unwanted jamming or shearing of the cable assembly when telescoping the pull-out device. This means that two functions can be provided by the longitudinally elastic cable assembly: On the one hand, a length compensation function and a protective function against mechanical damage to the longitudinally elastic cable assembly during telescoping of the pull-out device.

Depending on the selected rigidity of the insulated electrical conductors used, which can be adjusted, for example, by the material, the conductor cross-section and/or the thickness of the insulation and its material, no additional components are required to stabilize the shape of the longitudinally elastic cable assembly. As a rule, this also means that fewer connection points of the longitudinally elastic cable assembly to surrounding housings or structural parts are required than with conventional cable harnesses. This reduction in the number of necessary components leads directly to lower manufacturing and assembly costs as well as greater design freedom for the surrounding components of the longitudinally elastic cable assembly.

In this context, it is particularly preferable for the longitudinally elastic shape of the cable assembly to be helical and/or meandering shape.

A meandering-shaped longitudinally elastic design leads in particular to a plane, flat cable assembly, which preferably obtains its longitudinal elasticity through the meandering-shaped course of the electrical conductors in a plane. For the purposes of this application, the term meandering shape also includes all wave-like shapes of a cable assembly extending in one plane, such as sinusoidal, rectangular, sawtooth-shaped waveforms, which can realize a longitudinally elastic cable assembly.

For the purposes of this application, a helix shape, as exhibited by the cable assembly, is a curve that winds around an imaginary shell of a cylinder at a constant gradient. A helix shape can also be referred to as a helical shape, helical line shape, cylindrical spiral shape or spiral shape.

Preferably, the helical cable assembly has a minimum radius in the radial direction. Preferably, the helical cable assembly also has a maximum radius in the radial direction, which is greater than the minimum radius in the radial extension. It is also preferred that the minimum radial is constant in the axial direction and/or the maximum radius is constant in the axial direction.

Furthermore, it is preferred that the helical cable assembly has a large number of spiral windings. The desired compensation length of the helical cable assembly can be set in particular by the number of windings and the minimum and maximum radius.

Furthermore, it is advantageous that the insulations of the electrical conductors are firmly connected to each other so that the positioning of the electrical conductors in relation to each other is fixed in the helical cable assembly.

It is particularly preferred that the guide tube has an octagonal cross-sectional contour with a tube height H and that the minimum radius of the helical cable assembly corresponds to between 55-80% of the tube height H of the guide tube. The maximum radius of the helical cable assembly is preferably between 80-100% of the tube height H of the guide tube. If the maximum radius of the cable assembly corresponds to 100% of the tube height H of the guide tube, then the cable assembly lies against the guide tube and cannot “sag,” which further reduces the risk of crushing or collisions. If an outer radius smaller than 100% of the tube height H is selected, contact between the guide tube and the cable assembly can be prevented.

In this context, according to an advantageous further development of the invention, it would also be conceivable to integrate a helically pre-bent plastic rod or metal rod into the cable assembly to increase the spiral stiffness and define the minimum bending radius thereabove. This means that electrical conductors with a comparatively low stiffness can also be used to form the helical cable assembly.

The operating unit according to the invention is particularly suitable for steer-by-wire systems in which the force feedback actuator (FFA) is installed in or on the steering means, so that the associated elimination of the torque-transmitting steering shaft means that there is also installation space inside such a telescopic operating unit for the helical cable assembly. In this context, it is particularly preferable for the helical cable assembly to be coupled to a force feedback actuator at its axially displaceable end.

The force feedback actuator can be designed in particular as an electric motor. The motor can be designed as an axial flux motor or as a radial flux motor. It is also possible to design a motor configured as a radial flux motor as an internal or external rotor.

In principle, it is possible for the helical cable assembly to extend radially inside the pull-out device and/or radially outside the pull-out device. It is preferred that the longitudinally elastic cable assembly extends radially within the pull-out device and in particular within the axially stationary guide tube of the pull-out device. It is also preferred that the longitudinally elastic cable assembly extends at least in sections within the axially movable pull-out tube.

In this context, it is also advantageous that contact between the helical cable assembly and the inner surface of the guide tube can be avoided, as the guide tube can act as a heat-dissipating element for an internal electronic operating unit.

A strain relief for the helical cable assembly can advantageously be attached to the axially movable connection of the operating unit, which can also be referred to as the “outlet” of the pull-out.

The steering means can preferably be designed as a steering wheel. In principle, it would also be possible to design the steering device as a joystick, for example.

According to a further preferred further development of the invention, it can also be provided that a plurality of the electrical conductors are arranged one above the other in the radial direction, wherein particularly favorable radial and axial stiffnesses of the helical cable assembly can be realized. In particular, such helical cable assemblies have a comparatively high radial stiffness and a comparatively low axial stiffness and thus a favorable axial flexibility for axial adjustment.

It can be preferable for the helical cable assembly to surround the spindle in the axial direction, at least in sections. In this context, it is also advantageous that the helical cable assembly extends coaxially to the spindle and that the spindle passes through the helical cable assembly at least in sections. The advantage of this design is that it provides a particularly compact and reliable version of an operating unit.

Furthermore, according to an equally advantageous embodiment of the invention, it can be provided that the guide tube is axially stationary and the helical cable assembly extends at least in sections within the guide tube, which can also contribute to a high operational reliability of the operating unit, since the helical cable assembly extends at least in sections through axially stationary regions of the pull-out device and in these regions the risk of the cable assembly being crushed by telescoping components of the pull-out device is low.

According to a further particularly preferred embodiment of the invention, it can be provided that the spindle is surrounded by a protective sleeve at least in sections and that the helical cable assembly surrounds the protective sleeve at least in sections. This has the particular effect that the protective sleeve can provide further improved collision protection of the helical cable assembly against the spindle. In this context, it is further preferred that the protective sleeve is arranged in a non-rotatable manner, with the spindle being rotatable within the protective sleeve, which can also reduce abrasion between the protective sleeve and the helical cable assembly, for example. It can therefore also be preferable for the helical cable assembly to rest with its inner sheath surface on the protective sleeve, at least in sections. The protective sleeve is preferably molded from a plastic.

Furthermore, the invention can also be further developed in such a way that the longitudinally elastic cable assembly is accommodated, at least in sections, in a corresponding longitudinally elastic cable channel with a U-shaped cross-sectional contour. In this context, it is also preferable for the helical cable assembly to be accommodated, at least in sections, in a corresponding helical cable channel with a U-shaped cross-sectional contour. The advantage of this design is that the cable channel can act as a support to keep the elongated or helical cable assembly in shape and position. Due to the U-shaped profile, the cable channel can be made relatively rigid in the radial direction with a helix shape, while the one for length compensation remains relatively soft in the axial direction. With a helix shape, it is also preferable that the groove opening of the U-shaped profile points in an axial direction. The cable channel can also improve collision and crush protection for the helical cable assembly. The cable channel is preferably made of plastic. It is understood that the cable channel assumes this meander shape when the cable assembly has a meandering-shape design and the groove opening is then positioned in a radial direction, for example.

In an equally preferred embodiment of the invention, it can also be provided that the spindle is surrounded, at least in sections, by a helix element the direction of rotation of which is oriented in the opposite direction to the direction of rotation of the helical cable assembly and the helix element engages through the helical cable assembly at least in sections. For example, it would be conceivable for the helix element to rotate clockwise and the helical cable assembly to rotate counterclockwise. Such a helix element also makes it possible to optimize the crush and collision protection for the helical cable assembly.

It can also be advantageous to further develop the invention in such a way that the telescopic pull-out device has an energy absorption means which, when a predefined mechanical energy acting axially on the pull-out device is exceeded, enables energy to be absorbed in the axial direction by plastic deformation of the energy absorption means.

The advantage of this is that it increases safety for the user in the event of an accident. According to a further preferred embodiment of the object of the invention, it can be provided that the energy absorption means is designed in the form of material openings in the guide tube, which enables very simple but effective energy absorption, in particular since sufficient installation space for plastic deformation can also be provided inside the guide tube due to the flexibility of the helical cable assembly.

Depending on the loaded state, the material openings can be rectangular. Especially preferably, the material openings are designed to be substantially identical. It is also preferable that the material openings are positioned in a grid-like pattern across the outer surface of the guide tube. In principle, other shapes for the material openings would also be possible, such as with angled or wavy contours. Thus, the energy absorption means can be designed particularly preferably as a plasticizing metal framework.

Instead of the material openings, it would also be conceivable to install, screw and/or rivet a separate energy absorption means, which is sometimes also referred to as a crash element, to the guide tube.

Finally, the invention can also be advantageously embodied in such a way that the helical cable assembly comprises a first group of electrical conductors and a second group of electrical conductors, wherein the conductor cross-section of the first group of electrical conductors is different from the conductor cross-section of the second group of electrical conductors. In particular, this can be used to provide a helical cable assembly that has energizing conductors and control conductors, with the energizing conductors having the larger conductor cross-section and the control conductors having the smaller conductor cross-section. This means that combined power and control cable assemblies can be provided.

In this context, it is further preferred that the electrical conductors of the first group of electrical conductors are arranged radially one above the other and the electrical conductors of the second group of electrical conductors are arranged radially one above the other, wherein the first group of electrical conductors and the second group of electrical conductors extend axially spaced apart from each other in the helical cable assembly. This quasi-layered arrangement of the two conductor groups allows a particularly favorable axial flexibility and radial rigidity of the cable assembly to be formed.

The object of the invention can also be attained by a longitudinally adjustable operating unit for influencing, by a user, a direction of travel of a motor vehicle, comprising a telescopic pull-out device having a guide tube, in or on which at least a first pull-out tube is guided relative to the guide tube and is translationally movable by means of a rotatable spindle which extends axially parallel to the first pull-out tube, wherein the telescopic pull-out device is coupled on the one hand to a steering means, and a plurality of electrically insulated conductors extend axially through the telescopic pull-out device to electrically connect a first, axially stationary electrical connection to a second electrical connection which can be axially moved by the pull-out device, wherein the electrical conductors are combined to form a cable assembly which extends in the axial direction through the pull-out device and has a longitudinally elastic configuration. In particular, it can also be provided that the spindle extends outside the first pull-out tube. It can also be possible for the spindle to extend outside the guide tube. It is to be understood that all the preceding advantageous embodiments are also to be read in relation to this secondary embodiment of a longitudinally adjustable operating unit according to the invention.

Thanks to the axially parallel arrangement of the spindle, even more compact operating units can be realized.

The object of the invention is further attained by a kit-of-parts for forming a longitudinally adjustable operating unit for influencing, by a user, a direction of travel of a motor vehicle, comprising a telescopic pull-out device having a guide tube, in or on which a first pull-out tube is guided so as to be translationally movable relative to the guide tube, and a plurality of electrically insulated conductors combined into a helical cable assembly and configured to a mounting position extending axially through the pull-out device.

The advantage that results from this is that the components of the longitudinally adjustable operating unit that are to be mounted can be provided in a particularly convenient manner. The kit-of-parts can, for example, be a packaging unit.

Furthermore, it is possible to design the kit-of-parts as a compilation of separate storage containers for storing the individual components or the respective component groups of the kit-of-parts.

Finally, the object of the invention can also be attained by a steer-by-wire system for influencing, by a user, a direction of travel of a motor vehicle, comprising a longitudinally adjustable operating unit according to one of claims 1-11.

The invention is explained in more detail below with reference to figures without limiting the general concept of the invention.

In the figures:

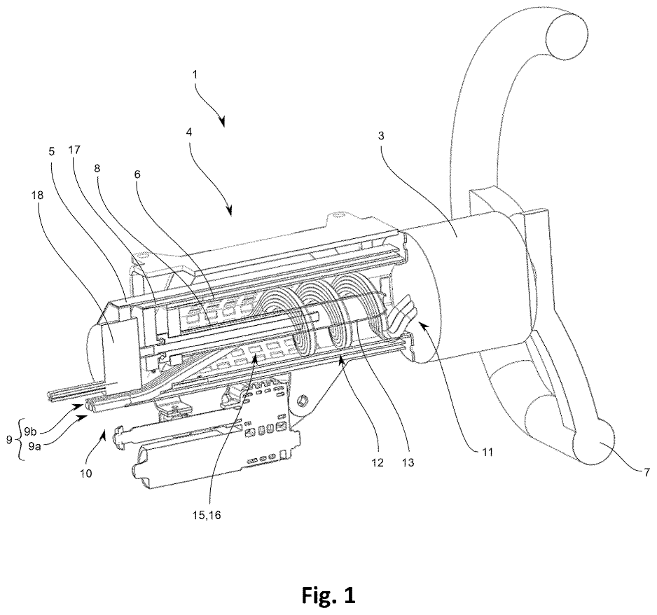

FIG. 1 shows a first embodiment of an operating unit in a perspective axial sectional representation,

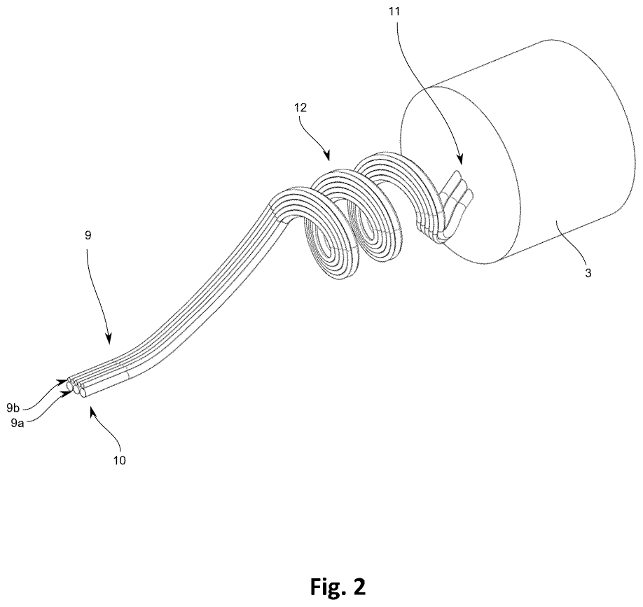

FIG. 2 shows an electric machine in a perspective view,

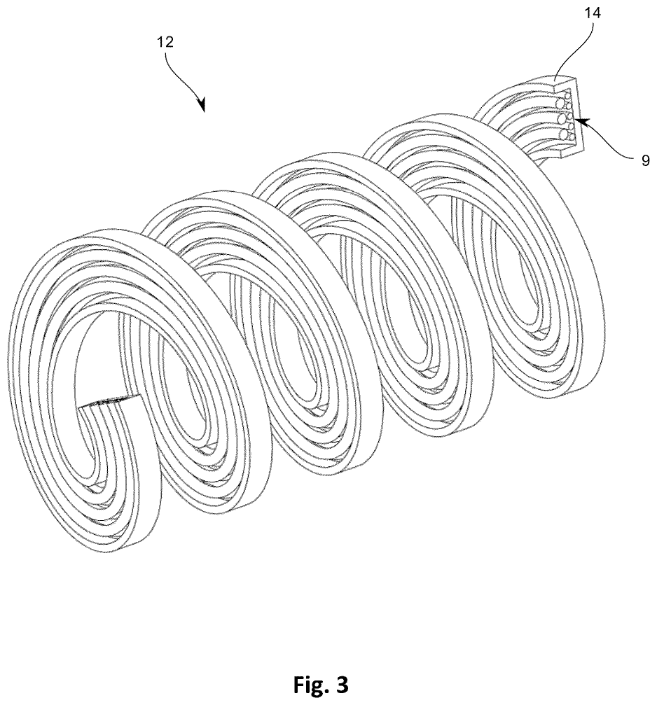

FIG. 3 shows a helical cable assembly in a U-shaped cable channel in an exposed perspective view,

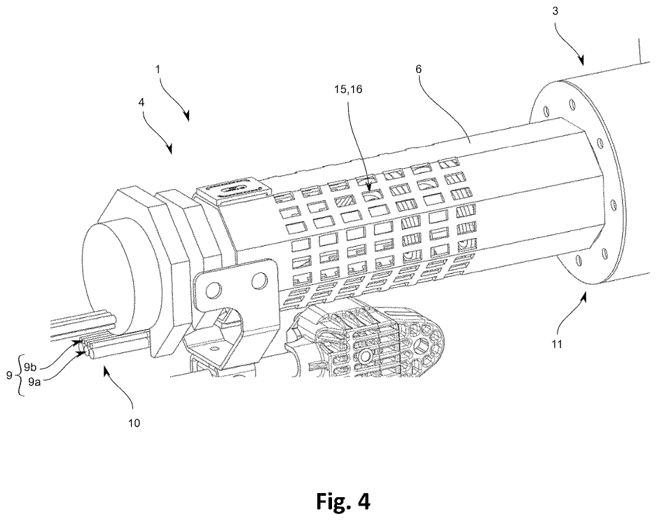

FIG. 4 shows a perspective representation of an embodiment of an operating unit with an exposed guide tube,

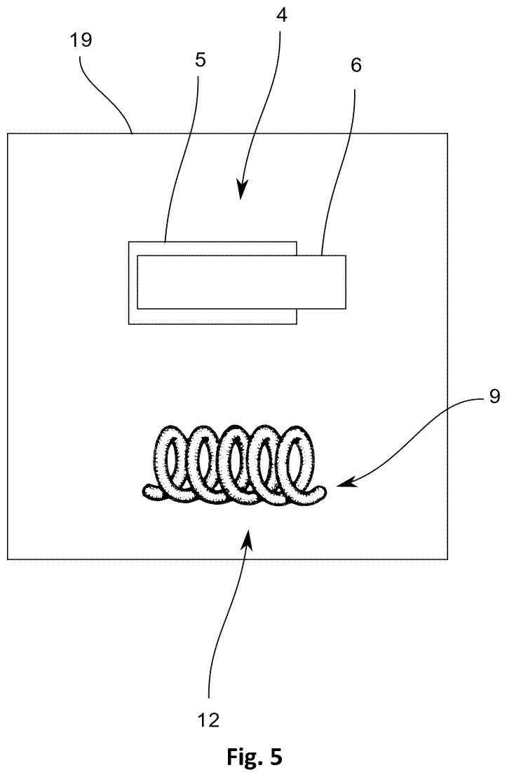

FIG. 5 shows a kit-of-parts in a schematic representation,

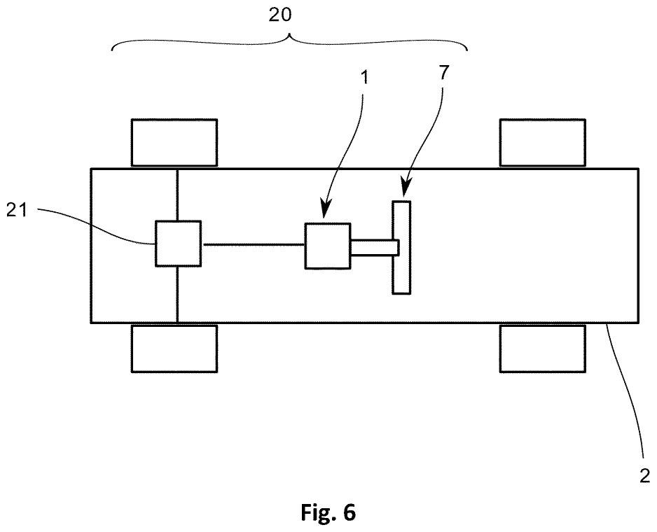

FIG. 6 shows a motor vehicle having a steer-by-wire system in a schematic block diagram,

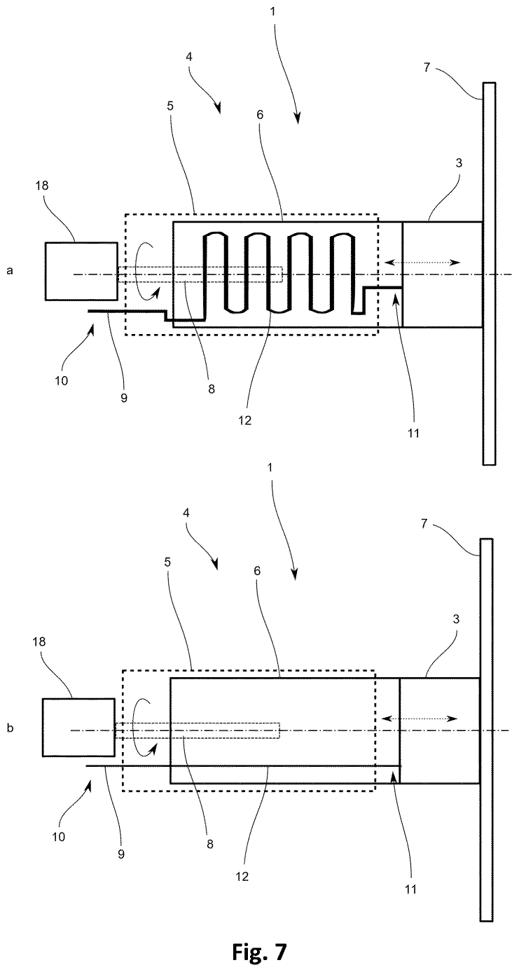

FIG. 7 shows a meandering-shaped cable assembly in a schematic representation.

FIG. 1 shows a longitudinally adjustable operating unit 1 for influencing, by a user, a direction of travel of a motor vehicle 2, comprising a telescopic pull-out device 4 having a guide tube 5, on which a first pull-out tube 6 is guided so as to be translationally movable relative to the guide tube 5. The first pull-out tube 6 is in turn surrounded by a second pull-out tube 17, wherein the second pull-out tube 17 is guided on the first pull-out tube 6 so that it is translationally movable. The pull-out tubes 6, 17 and the guide tube 5 are arranged so that they cannot rotate relative to each other by having a polygonal contour, which prevents the tubes 5, 6, 17, which are formed from a sheet metal, from rotating relative to each other.

The pull-out tubes 6, 17 of the pull-out device 4 are translationally movable by means of a rotatable spindle 8 which can be driven by the motor 18 and which extends coaxially and axially at least in sections in the first pull-out tube 6. Even if it is not shown in FIG. 1, it is still possible that the rotatable spindle 8 does not extend coaxially as shown, but parallel to the axis of the first pull-out tube. In particular, it can also be provided that the spindle 8 extends outside the first pull-out tube 6. It is also possible that the spindle 8 extends outside the guide tube 5. Due to the axially parallel arrangement of the spindle 8, operating units 1 which are axially even more compact can be realized.

The telescopic first pull-out tube 6 is coupled to a force feedback actuator 3, which in turn is connected to a steering means 7. The force feedback actuator 3 is therefore translationally movable together with the steering means 7 via the pull-out device 4. FIG. 1 shows the pull-out device 4 in its fully retracted operating state and it is easy to see how the spindle 8 engages in the guide tube 5 and the pull-out tubes 6, 17.

A plurality of electrically insulated conductors 9 extend axially through the telescopic pull-out device 4 to electrically connect a first, axially stationary electrical connection 10 to a second electrical connection 11, which can be axially moved by the pull-out device 4. In the design example shown, the axially movable electrical connection 11 is the force feedback actuator 3. However, the axially movable electrical connection 11 could also be an operating unit of the operating unit 1 or similar.

FIG. 1 clearly shows that the electrical conductors 9 are combined to form a helix-shaped cable assembly 12 extending axially through the pull-out device 4. A plurality of the electrical conductors 9 are arranged one above the other in a radial direction in the area of the helix shape.

This helical cable assembly 12 extends coaxially to the spindle 8 and the spindle 8 passes through the helical cable assembly 12 at least in sections.

The guide tube 5 is axially stationary and the helical cable assembly 12 extends at least in sections within the first pull-out tube 6, wherein the helical cable assembly 12 does not contact the inner lateral surface of the pull-out tube 6. In the embodiment shown in FIG. 1, the spindle 8 is surrounded by a protective sleeve 13, while the helical cable assembly 12 surrounds the protective sleeve 13 at least in sections and can rest with its inner radius on the outer surface of the protective sleeve 13. The protective sleeve 13 is designed to be non-rotatable so that there is no relative movement between the protective sleeve 13 and the cable assembly 12 in the circumferential direction.

FIG. 3 shows an embodiment of the helix-shaped cable assembly 12, in which the helix-shaped cable assembly 12 is accommodated at least in sections in a corresponding helix-shaped cable channel 14 having a U-shaped cross-sectional contour.

FIG. 4 clearly shows that the telescopic pull-out device 4 has an energy absorption means 15 which, when a predefined mechanical energy acting axially on the pull-out device 4 is exceeded, enables energy to be absorbed in the axial direction by plastic deformation of the energy absorption means 15. In the embodiment shown, the energy absorption means 15 is in the form of material openings 16 in the guide tube 5.

Finally, FIG. 2 clearly shows that the helical cable assembly 12 has a first group of electrical conductors 9a and a second group of electrical conductors 9b, wherein the conductor cross-section of the first group of electrical conductors 9a is different from the conductor cross-section of the second group of electrical conductors 9b. The electrical conductors 9 of the first group of electrical conductors 9a are arranged radially one above the other in the area of the helix shape and the electrical conductors 9 of the second group of electrical conductors 9b are also arranged radially one above the other in the area of the helix shape, with the first group of electrical conductors 9a and the second group of electrical conductors 9b running axially spaced apart from one another in the area of the helix shape in the helical cable assembly 12. Such an arrangement of electrical conductors 9 is sometimes also referred to as a flat cable. It has proven to be particularly favorable for the formation of the necessary longitudinal elasticity 22 that, viewed in cross-section, the ratio of the width of the cable assembly 12 to the height of the cable assembly 12 is at least 3:1.

FIG. 5 shows a kit-of-parts 19 for forming a longitudinally adjustable operating unit 1 for influencing, by a user, the direction of travel of a motor vehicle 2. It comprises a telescopic pull-out device 4 having a guide tube 5, in or on which a first pull-out tube 6 is guided so as to be translationally movable relative to the guide tube 5, and a plurality of electrically insulated conductors 9, which are combined to form a cable assembly 12 having a longitudinally elastic shape and are configured to a mounting position extending in the axial direction through the pull-out device 4. In the example shown, the cable assembly is helical.

Finally, FIG. 6 shows a steer-by-wire system 20 for influencing, by a user, the direction of travel of a motor vehicle 2, which has a longitudinally adjustable operating unit 1, as is known, for example, from FIG. 1.

The operating unit 1 is connected to the steering wheel 7 and transmits the current steering wheel angle as an electronic signal via the on-board vehicle electronics to the RWA (road wheel actuator) 21, which then applies the steering wheel angle to the vehicle wheels using a motor. The operating unit 1 also provides the driver with the necessary force feedback for the directional control of the vehicle 2. For vehicle concepts with highly automated driving functions, the operating unit 1 can have a telescopic device 4 with a large travel range of >200 mm, with which the steering wheel 7 can be retracted into the dashboard. The operating unit 1 has a force feedback actuator 3, which determines the steering wheel angle and generates the force feedback steering wheel forces.

FIG. 7 shows an alternative version of the cable assembly 12 in a meander shape. This meandering shape, unlike the helix shape, extends in one plane. This is illustrated by the two different views of the operating unit 1 in FIG. 7. Figure a shows the operating unit 1 in a top view in the direction of gravity, while Figure b shows a side view of the operating unit, analogous to the illustration in FIG. 1. The meander shape makes it possible, for example, for such a meandering-shaped cable assembly 12 to be laid on the bottom of the first pull-out tube 6 and thus extends through the pull-out tube 6 in the direction of gravity below the spindle 8, as shown in Figure b of FIG. 7.

The invention is not limited to the embodiments shown in the figures. The above description is therefore not to be regarded as limiting, but rather as illustrative. The following claims are to be understood as meaning that a stated feature is present in at least one embodiment of the invention. This does not exclude the presence of further features. Where the claims and the above description define “first” and “second” features, this designation serves to distinguish between two features of the same type without defining an order of precedence.

### LIST OF REFERENCE SYMBOLS

1 Operating unit
2 Motor vehicle
3 Force-feedback actuator
4 Pull-out device
5 Guide tube
6 Pull-out tube
7 Steering equipment
8 Spindle
9 Electrical conductor
10 Axially stationary electrical connection
11 Axially movable electrical connection
12 Cable assembly
13 Protective sleeve
14 Cable channel
15 Energy absorption means
16 Material openings
17 Pull-out tube
18 Motor
19 Kit-of-parts
20 Steer-by-wire system
21 RWA (road wheel actuator)

1. A longitudinally adjustable operating unit for influencing, by a user, a direction of travel of a motor vehicle, the longitudinally adjustable operating unit comprising:
a telescopic pull-out device coupled to a steering means, the telescopic pull-out device having a guide tube, in or on which at least a first pull-out tube is guided relative to the guide tube, the first pull-out tube and is-translationally movable via a rotatable spindle extending coaxially and axially at least in sections in the first pull-out tube, and
a plurality of electrically insulated conductors extending axially through the telescopic pull-out device to electrically connect a first axially stationary electrical connection to a second electrical connection configured to be axially moved by the telescopic pull-out device, and
the plurality of electrically insulated conductors are combined to form a cable assembly which extends axially through the telescopic pull-out device and has a longitudinally elastic shape.

2. The longitudinally adjustable operating unit according to claim 1, wherein the longitudinally elastic shape of the cable assembly is a helical and/or meandering shape.

3. The longitudinally adjustable operating unit according to claim 2, wherein the cable assembly encloses the rotatable spindle in an axial direction at least in sections.

4. The longitudinally adjustable operating unit according to claim 2, wherein each one of the plurality of electrically insulated conductors is arranged one above another in a radial direction.

5. The longitudinally adjustable operating unit according to claim 2, wherein the guide tube is axially stationary and the cable assembly extends at least in sections within the guide tube.

6. The longitudinally adjustable operating unit according to claim 2, wherein the rotatable spindle is surrounded at least in sections by a protective sleeve and the helical cable assembly surrounds the protective sleeve at least in sections.

7. The longitudinally adjustable operating unit according to claim 2, wherein the cable assembly is received at least in sections in a corresponding longitudinally elastic cable channel having a U-shaped cross-sectional contour.

8. The longitudinally adjustable operating unit according to claim 2, wherein the rotatable spindle is surrounded at least in sections by a helix element, the direction of rotation of which is oriented in the opposite direction to the direction of rotation of the cable assembly and the helix element engages at least in sections through the cable assembly.

9. The longitudinally adjustable operating unit according to claim 2, wherein the cable assembly comprises a first group of electrical conductors and a second group of electrical conductors, a conductor cross-section of the first group of electrical conductors being different from a conductor cross-section of the second group of electrical conductors.

10. The longitudinally adjustable operating unit according to claim 9, wherein electrical conductors of the first group of electrical conductors are arranged radially one above another and electrical conductors of the second group of electrical conductors are arranged radially one above another, and the first group of electrical conductors and the second group of electrical conductors extend axially spaced apart from one another in the helical cable assembly.

11. A longitudinally adjustable operating unit for influencing, by a user, a direction of travel of a motor vehicle, the longitudinally adjustable operating unit comprising:
a telescopic pull-out device coupled to a steering means, the telescopic pull-out device having a guide tube in or on which at least a first pull-out tube is guided relative to the guide tube, the first pull-out tube translationally movable via a rotatable spindle extending axially parallel to the first pull-out tube, and
a plurality of electrically insulated conductors extending axially through the telescopic pull-out device to electrically connect a first axially stationary electrical connection to a second electrical connection configured to be axially moved by the telescopic pull-out device, and
the plurality of electrically insulated conductors are combined to form a cable assembly which extends in an axial direction through the telescopic pull-out device and has a longitudinally elastic shape.

12. A kit-of-parts for forming a longitudinally adjustable operating unit for influencing, by a user, a direction of travel of a motor vehicle, the kit-of-parts comprising:
a telescopic pull-out device having a guide tube, in or on which a first pull-out tube is guided so as to be translationally movable relative to the guide tube, and
a plurality of electrically insulated conductors combined to form a cable assembly having a longitudinally elastic shape and are configured to a mounting position extending in an axial direction through the telescopic pull-out device.

13. A steer-by-wire system for influencing, by a user, a direction of travel of a motor vehicle, the steer-by-wire system comprising a longitudinally adjustable operating unit according to claim 1.

14. The longitudinally adjustable operating unit of claim 11, wherein the telescopic pull-out device further comprises material openings configured to absorb energy in the axial direction via plastic deformation of the material openings.

15. The longitudinally adjustable operating unit of claim 11, wherein the guide tube and the first pull-out tube are shaped so that they can not rotate relative to each other.

16. The longitudinally adjustable operating unit of claim 11, wherein the guide tube and the first pull-out tube are polygonal-shaped so that they can not rotate relative to each other.

17. The longitudinally adjustable operating unit of claim 11, wherein the cable assembly comprises a first group of energizing conductors and a second group of control conductors.

18. The longitudinally adjustable operating unit of claim 11, wherein the longitudinally elastic shape of the cable assembly is helical.

19. The longitudinally adjustable operating unit of claim 18, wherein the cable assembly encloses the rotatable spindle in the axial direction.

20. The longitudinally adjustable operating unit of claim 11, wherein the cable assembly forms a wave-like shape extending in one plane.
